(19) United States
(12) Patent Application Publication
(10) Pub. No.: US 2021/0189673 A1
(43) Pub. Date: Jun. 24, 2021

(54) HEATING DEVICE FOR RAILWAY TRACKS

(71) Applicant: SWERAIL AB, Västerås (SE)

(72) Inventor: Ulf Holgersson, Västerås (SE)

(21) Appl. No.: 17/059,327

(22) PCT Filed: May 27, 2019
(86) PCT No.: PCT/EP2019/063682

§ 371 Date: Nov. 27, 2020

(30) Foreign Application Priority Data
Jun. 5, 2018 (SE) 1850680-8

(51) Int. Cl. E01H 8/08; E01B 19/00

(52) U.S. Cl. CPC E01H 8/08; E01B 19/00

(57) ABSTRACT

The present invention relates to heating device for melting snow and ice from a railway track, wherein the heating device comprises a connection plate (3), a heat element (5) attached to the connection plate, and at least one securing member (7) for securing the connection plate to the track. The securing member (7) is configured to clamp a part of the track between the securing member (7) and the connection plate. An outer portion (8) of the connection plate (3) is bent inwards so that a hook (11) is formed at an end (4a) of the connection plate for receiving a part of the track, and the hook is provided with at least one through hole (16) for receiving the at least one securing member.

### TECHNICAL FIELD

The present invention relates to a device for removing snow and ice from railway tracks and from rail road switches by heating the tracks. The present invention relates to the use of the heating device.

### BACKGROUND

In winter climates it is necessary to keep railway tracks free from snow and ice. Different types of heating devices exist for removing ice and snow. Current solutions for maintaining and keeping railroad switches clean from snow and ice during the cold season has proven difficult in form of energy efficiency and sufficient mechanical means of fitting the devices to the rail or railroad switches in a secure manner. The equipment has a tendency to be bulky and is not cost-effective. Furthermore, the time needed for new installations and/or maintenance of existing installations causes delay and additional costs for railroad companies.

Today, there is a trend towards a higher use of railways for transportation of goods and people, which has led to a higher utilization of railways. This has resulted in maximum capacity being reached or almost reached in many places. Hence railways must constantly be accessible and there is little or no time to use manual or conventional mechanical means to remove ice or snow from the tracks.

WO2012050502 discloses a heating device for removal of snow and ice from railway tracks. The device comprises a magnetic field generator fed with a low-frequency current. The magnetic field generator is operative to work in conjunction with a heat element in which the magnetic field generated by the magnetic field generator is transformed into heat. The heat element can be a section of the railway or some other metal portion. The heat element can be combined with a heat spreader. The purpose of the heat spreader is to spread the heat generated in the heat element over a larger area. The heat spreader can be secured to the railway tracks by means of a securing member. The securing member can be clamped around a bottom section of the railway tracks A disadvantage of this heating device for removing snow and ice from railway tracks is that it is bulky and complicated mounting to the tracks.

A serious issue for the crews installing current devices is the type of securing members used today. The part of the securing member that is clamping the device to the track is installed between the inner moving part (tongue) of the switch and the outside rail of the switch. This forces the crew mounting the device to have their hands and arms in a very dangerous position during the installation. A switch operates with up to 800 kg force and would cause severe injuries if moved by mistake.

Usually, 24 heating devices are needed for removal of snow and ice from one single rail road switch. Accordingly, it takes a long time to install the heating devices for a switch. This is negative for the railway company, since the railway track must be closed during installation and maintenance of the heating devices. Another problem is a risk that the connection between the heating device and the track will loosen due to vibrations or maintenance of the track.

U.S. Pat. No. 1,957,977 shows a heating unit comprising an electrical resistance element and protective casing adapted for clamping to the underside of a rail base between the ties. The protective casing comprising upper and lower separable sections formed to house the electrical resistance element therebetween. The upper section is provided with securing means for attaching the heating unit to the rail. The securing means comprises a shoulder attached to the upper section and a set screw to engage the rail for securing the heating unit to the rail. The shoulder and the upper section define a space with an opening for receiving a part of the rail. The protective casing and the shoulder are made of cast iron, which is sensitive to elongation due to temperature changes. A problem with this heating unit is that it is complicated to manufacture. Further, the heating unit has problem to withstand vibrations in the track caused by trains running on the track. Clamping of the rail in combination with vibrations in the rail and changes in the material due to temperature differences may cause large problems. In a worst case, the temperature differences may cause the heating device to crack due to vibrations in the track. The device also lacks any heat management or conserving features.

### SUMMARY

The aim of invention is to at least partly overcome the above problems, and to provide an improved heating device for removing snow and ice from railway tracks including railway switches.

This aim is achieved by a heating device as defined in claim 1.

The heating device comprises a connection plate, a heat element attached to the connection plate, and at least one securing member for securing the connection plate to the track, and the securing member is configured to clamp a part of the track between the securing member and the connection plate. An outer portion of the connection plate is bent inwards so that a hook is formed at an end of the connection plate for receiving a part of the track, and the hook is provided with at least one through hole for receiving the at least one securing member.

The connection plate of the present invention is easy to manufacture. For example, a solid metal plate can be used. The hook can easily be created by simply bending the outer portion of the connection plate inwardly. Thus, the heating device according to the invention is easy to manufacture.

Further, since the hook is formed at one end of the connection plate by bending the outer portion of the connection plate inwards, the hook becomes robust, and can hence withstand high pressure from the securing member when the securing member clamps a part of the track between the securing member and the connection plate. The resulting counterforce secure a high surface pressure between the connection plate and the track, which improves the conduction of heat from the heating device to the track, and accordingly improves the ability to melt snow and ice on the track.

The track comprises a rail, and with the term “a part of the tack” is meant a part of the rail.

In one aspect, the connection plate is solid and made in one piece. The connection plate is solid, which means that the interior of the plate is compact and not hollow. This makes it easy to manufacture the connection plate. Further, the connection plate becomes robust.

In one aspect, the heat element is arranged on the outside of the connection plate. Thus, mounting of the heating element becomes simple. Further, the connection plate does not need to have any interior space for housing the heat element, which makes it easier to manufacture the connection plate and makes the connection plate more robust. Since there is no need for a hollow interior of the connection plate, the connection plate can be made solid, and by that the strength of the connection plate is increased.

The connection plate comprises a flat section and the hook is formed between the bent part of the connection plate and the flat section at one end of the connection plate.

High pressure is required between the rail and the connecting plate to achieve necessary transfer of heat or energy between the rail and the connecting plate for the arrangement to work as a homogeneous system. The system will slowly accumulate heat in the rail by means of transfer from the heat element through the connecting plate to the rail and then on moment's notice, when ice blocks are dropped from passing trains, return the accumulated energy from the rail to the connecting plate to clear the area between the rail and tongue by melting off lodged ice. Thus, to achieve an efficient conduction of heat between the connection plate and the rail, the surface pressure between the rail and the connection plate must be high. Preferably, the pressure between the rail and the connecting plate is at least 1.5 MPa.

In one aspect, the connection plate is made of a resilient material. In order to achieve the necessary surface pressure between the rail and the connection plate, the connection plate preferably is made of a material which has resilient properties. Due to the fact that the connection plate is made of a resilient material and the hook is formed by bending one end of the connection plate inwards, the bent part of the hook becomes resilient in relation to the flat section of the connection plate. The resilient material allows stretching without cracking and consequently is suitable to use in this application where clamping in connection with vibrations and temperature differences is a fact. Thus, the hook can withstand vibrations in the rail as well as structural changes in the connection plate due to changes in the temperature at the same time as the securing member apply high tension on the connection plate.

The system with heat accumulation and transfer can save up to 75% of the energy used by older existing heating systems.

In one aspect, the connection plate is made of steel. Steel is a resilient material, but it can become more resilient by going through a hardening process.

Alternatively, the connection plate is made of aluminum or alloys thereof. Aluminum is a resilient material. For example, the connection plate can be made of extruded aluminum or aluminum alloy.

In one aspect, the connection plate is made of high-tensile steel. In this application, high-tensile steel is defined as steel having a tensile strength >700 MPa. This will make the steel sufficiently resilient.

The term tensile strength used in the present application refers to the Yield strength, and is defined as the stress a material can withstand without permanent deformation.

In one aspect, the connection plate is made of high-tensile aluminum or alloys thereof. In this application, high-tensile aluminum and alloys thereof is defined as aluminum and aluminum alloys having a tensile strength >350 MPa. This will make the aluminum and the aluminum alloys sufficiently resilient.

In one aspect, the connection plate is made of high-tensile steel or high-tensile aluminum or alloys thereof.

The flat section and the bent part together form a hook in one end of the connection plate.

The hook defines a space with an opening for receiving a part of the track. The opening of the space is facing towards the center of the connection plate. Thus, one end of the connection plate is designed as a hook having an opening for receiving a part of the track. The other end of the connection plate does not have any hook, and preferably has a thickness less than the distance between the rail and the ballast to allow the other end to be easily inserted underneath the track and above the ballast

The securing member is arranged to clamp a part of the track between the securing member and the first section of the connection plate using the flat section as a restraint.

The heat element is fitted under a railroad track by means of the connection plate. The connection plate is constructed in a way that will make it possible to fit the heat element to the railroad—track in a manner that will secure maximal heat conductivity between the heating device and the rail and therefore minimizing heat and energy loss. The device radically reduces energy consumption vs. older existing heating systems.

The connection plate is used to fit the heating device to the rail or railroad switch, by means of the securing member. The connection plate makes it possible to install the heating device in direct proximity of the rail or the switchgear. The location of the heating element is critically important to reduce energy losses through heat transfer to the surrounding equipment or environment.

The heating device provides means of an easy application. The connection plate makes it possible to install an individual heating device within minutes from one side of the rail and without the need to use any securing member or restraint on the corresponding side of the track. This will reduce the amount of time to install the device and minimize the exposure and hazards for maintenance and railroad crews.

Due to the design of the connection plate, it is possible to reduce the thickness of the heating device to a minimum therefore reducing potential removal of ballast under the rail when the heating device is installed.

The connection plate can be a passive mechanical solution to fit the heating element to the rail or the railroad switch or can be an intricate part of the construction where the shape and size of the connection plate is used for heat transfer and melting of snow and ice.

The connection plate protects the heating element from damage due to machine or labor induced cleaning of ice and snow.

The through hole is an opening in the bent part for receiving the securing member. In one aspect, the flat section is plate shaped.

According to an aspect, the other end of the connection plate has a thickness of less than 45 mm, and preferably less than 40 mm to allow the other end to be easily inserted underneath the track and above the ballast.

According to an aspect, the at least one through-hole and the at least one securing member are provided with engagement elements configured to engage with each other and by that lock the securing member in a fixed position relative the connection plate. For example, the engagement elements are threads.

According to an aspect, an end of the securing member is provided with a pointed tip. The pointed tip makes it easier for the securing member to resist vibrations in the railway track, and accordingly improves the attachment of the heating device to the track.

According to an aspect, the first section defines a first plane, the second section defines a second plane, and the angle between the first and second planes is less than 25°. Thus, the securing member will act with a sufficient force on the part of the track clamped between the securing member and secure heat transfer and keep the part of the track in place even when there are vibrations in the track.

According to an aspect, the heat element is an electric heater comprising an electric resistor. By using an electric heater, it possible to make the heat element thin enough to allow the heat element together with the connection plate to be inserted underneath the railway track during mounting of the heating device.

According to one aspect, the heat element is plate shaped and the thickness of the heat element is less than 30 mm, and preferably less than 20 mm to reduce the total thickness of the heating device.

According to one aspect, the heating device comprises an electrically insulating member, which conducts heat, and is disposed between the heat element and the connection plate to avoid short circuit between the heat element and the connection plate.

According to an aspect, the thickness of the heat element and the first section of the connection plate together is less than 45 mm, and preferably less than 40 mm. Thus, insertion of the connection plate underneath the track is facilitated during mounting of the heating device. Further, there is minimal if any need for removing ballast underneath the track to allow insertion of the connection plate and the heat element.

According to an aspect, the thickness of the first section of the connection plate is less than 30 mm, and preferably less than 25 mm.

According to an aspect, the width of the first section of connection plate is more than 100 mm, and preferably larger than 150 mm. Thus, a large heat transfer area is achieved.

According to an aspect, the length of the connection plate is more than 100 mm, and preferably larger than 150 mm.

According to an aspect, the device comprises a stop element attached to the connection plate at a distance from the opening. Thus, the track is prevented from moving away from the space, for example, due to vibrations or impact from maintenance work of the track.

Preferably, the height of the stop element is less than 10 mm in order to allow the connection plate 3 with the stop element to be inserted underneath the track during mounting of the heating device and/or to prevent interference with the moving parts of the railroad switch

Use of the heating device for heating a railway switch including a rail and a tongue arranged movable relative the rail, and the connection plate is arranged so that it extends between the rail and the tongue of the switch to allow snow and ice between the rail and the tongue to be melted.

### BRIEF DESCRIPTION OF THE DRAWINGS

The invention will now be explained more closely by the description of different embodiments of the invention and with reference to the appended figures.

FIG. 1 shows one example of a heating device according to the invention.

FIG. 2 shows a cross-section through the connection plate.

FIG. 3 shows the heating device connected to a rail of a railway track.

FIG. 4a shows a view from above of a railway switch provided with a plurality of heating devices.

FIG. 4b shows a cross-section A-A through the railway switch shown in FIG. 4a.

FIG. 5 shows another example of a heating device according to the invention.

### DETAILED DESCRIPTION

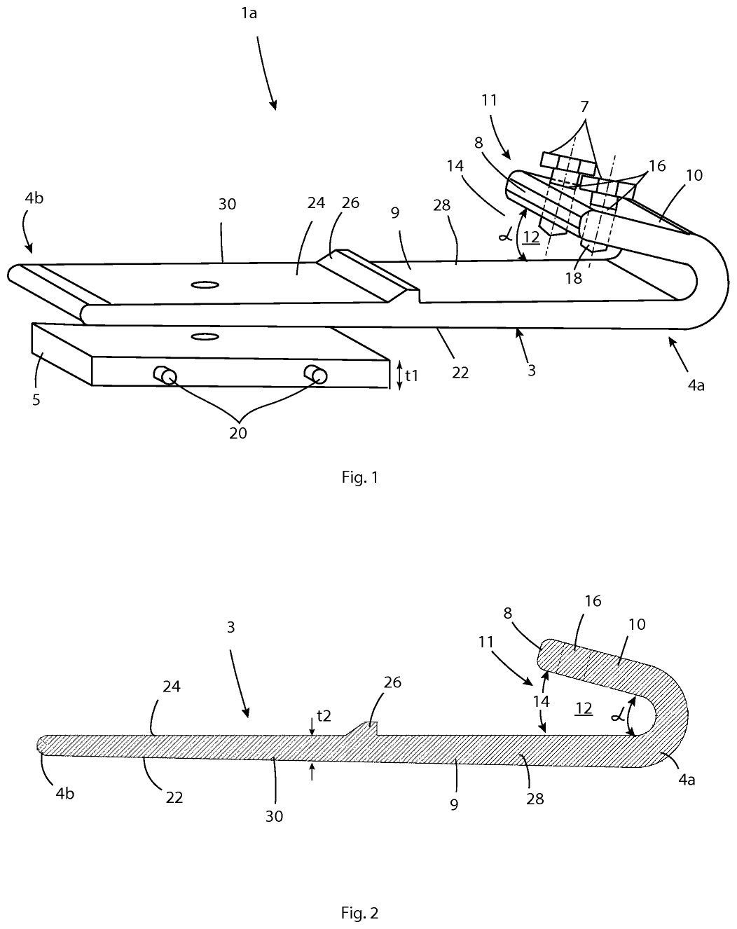

FIG. 1 shows a first example of a heating device 1a for removing snow and ice from a railway track according to the invention. The heating device 1a comprises a connection plate 3 having a first end 4a and a second end 4b, a heat element 5 attached to the connection plate, and at least one securing member 7 for securing the connection plate to the track. The heat element 5 is arranged on the outside of the connection plate 3.

An outer portion 8 of the connection plate 3 is bent inwards so that a hook 11 is formed at the first end 4a of the connection plate for receiving a part of the track. The hook 11 is provided with at least one through hole 16 for receiving the at least one securing member. Preferably, the connection plate 3 is made of a resilient material. For example, the connection plate 3 is made of steel or aluminum.

The connection plate 3 comprises a first section 9, and a second section 10 that is bent inwards relative to the first section 9 so that the hook 11 is formed between the first and second sections at one end of the connection plate, wherein the hook 11 defines a space 12 with an opening 14 for receiving a part of the track. The part of the track is a part of a bottom section of the rail.

The space 12 and the opening 14 have a shape and size adapted to receive a part of a bottom section of a rail. The heat element 5 is attached to the first section 9.

The second section 10 is provided with at least one through hole 16 for receiving the at least one securing member 7. The through hole is, for example, a bore. In this example, the heating device 1a comprises two securing members 7, and the second section 10 is provided with two through holes 16 for receiving the securing members 7. However, the number of through holes and type and number of securing members can vary. In one aspect, the least one through hole 16 and the at least one securing member 7 are provided engagement elements (not shown) configured to engage to each other and by that lock the securing member 7 in a fixed position relative the connection plate 3. The engagement elements are, for example, threads.

The securing member 7 is, for example, a threaded bolt or a screw. The securing member 7 is preferably elongated. In this example, the securing members 7 are threaded bolts. The through holes 16 are provided with threads configured to engage with the threads on the bolts, to allow the bolts to be moved relative the first and second sections, and to lock the securing member in relation to the second section 10, when the part of the track is clamped between the first section 9 and the securing member. In this example, the securing member 7 is provided with a pointed tip 18. The pointed tip 18 makes it easier for the securing member 7 to keep the part clamped between the securing member 7 and the first section 9 when there are vibrations in the railway track, and accordingly improves the attachment of the heating device to the track.

In this example, the heat element 5 is an electric heater comprising an electric resistor. The resistor is, for example, a tubular heating element embedded in a heat conducting material. For example, the heat element 5 comprises a tubular heating element embedded in aluminum or aluminum alloy. The heat element is flat, and the thickness t1 of the heat element is less than 30 mm and preferably less than 20 mm. The heat element 5 is provided with connection elements 20 for connection of the electric resistor to an electric power source. The heat element can be removably attached to the connection plate. For example, the heat element is attached to the connection plate by means of a bolt. In this example, the heat element is attached to a bottom surface 22 of the first section 9 of the connection plate. However, in another embodiment, the heat element can be attached to an upper surface 24 of the first section 9, as shown in FIG. 5. The heat element 5 has a contact surface adapted to be in thermal contact with the connection plate.

FIG. 2 shows a cross-section through an example of the connection plate 3. The connection plate 3 is solid and made in one piece, as seen in the figure. The first and second sections 9, 10 are designed so that the first end 4a of the connection plate 3 is shaped as a hook 11. In one aspect, the hook is U-shaped. The outer portion 8 of the connection plate 3 is bent inwards so that the hook 11 is formed at the first end 4a. The first section 9 is flat and plate shaped and defines a first plane. In this example, the second section 10 is flat and plate shaped and defines a second plane. There is a curved section located between the first and second sections 9, 10. Preferably, the angle α between the first and second planes is less than 25° so that the securing member will act with a sufficient force on the part of the bottom section of the rail that is clamped between the securing member 7 and the first section 9 to keep the part in the space 12 secure heat transfer even when there are vibrations in the rail. In this example, the angle α is about 15°, However, the angle α may vary, for example, between 0-25°.

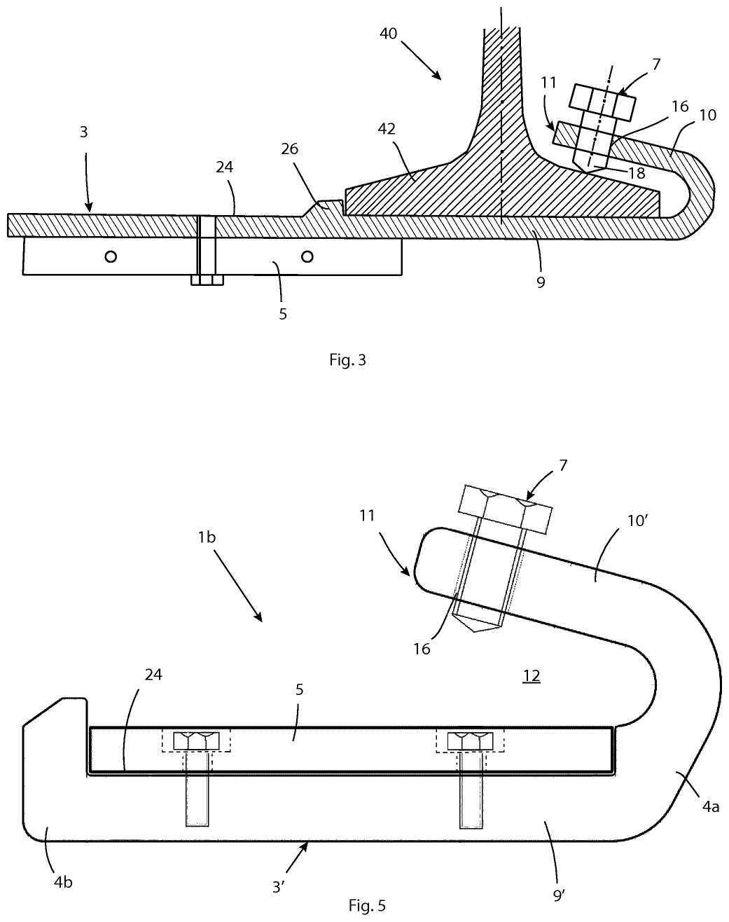

According to one aspect, the angle α between the first and second plane is larger than 5°. The angle α between the first and second planes should suitably be adapted to the angle of the bottom section of the railway tracks. Preferably, the second section 10 has an angle α in relation to the first section 9 which corresponds to the angle of the bottom section of the rail, so that the securing member 7 will be arranged perpendicular to the surface of the bottom section and allowing to improve the attachment between the railway track and the heating device. However, the shape of the bottom section of the rails varies. Thus, the angle α may vary depending on the type of bottom section. Suitably, the angle α may vary between 0° and 25°. If the upper surface of the bottom section 42 is sloping, as shown in FIG. 3, the angle α may vary between 5° and 25°.

Preferably, the connection plate 3 is made of a heat conducting material with resilient properties. For example, the connection plate is made of high-tensile steel or high-tensile aluminum, or high-tensile aluminum alloys. Such materials have a high thermal conductivity, suitable strength, and suitable resilient properties. Preferably, the thickness t2 of the first section 9 of the connection plate is less than 30 mm, and preferably less than 25 mm to facilitate insertion of the first section 9 of the connection plate underneath the rail. The thickness of the first section of the connection plate depends on the material of the connection plate due to different mechanical strength of different material. For example, a connection plate made in aluminum needs a thickness of about 20 mm to achieve enough mechanical strength, and a connection plate made in steel needs a thickness of about 10 mm to achieve enough mechanical strength.

High pressure is needed between the rail and the connecting plate to achieve necessary transfer of heat or energy between rail and connecting plate. To achieve enough contact pressure to transfer heat between rail and connecting plate, the connecting plate can, for example, be made of high-tensile steel (tensile strength >700 MPa) or high-tensile aluminum or aluminum alloys (tensile strength >350 MPa) be used, which can create spring tension between the first plane and the second plane of the connecting plate. The momentum and resulting counterforce generated by tightening of the securing member 7 create a significant pressure, preferably more than 1.5 MPa, between the connecting plate and the rail. The pressure is necessary for good heat conductivity between the connecting plate and the rail.

The term tensile strength used in the present application refers to the Yield strength, and is defined as the stress a material can withstand without permanent deformation.

Optionally, the heating device 1a comprises a stop element 26 to ensure that the clamped part of the track is not moved away from the space 12 due to vibrations in the rail. The stop element 26 is protruding from the upper surface 24 of the first section 9 at a distance from the opening 14 of the space 12. The distance between the stop element 26 and the opening 14 depends on the size of the bottom section of the rail. In this example, the stop element 26 is a ridge extending across the first section 9.

The first section 9 of the connection plate can be rectangular. For example, the connection plate is about 300×300 mm. However, the connection plate may have other shapes.

In this example, the first section 9 comprises an inner portion 28 and an outer portion 30, as shown in FIG. 2. The heat element 5 is attached to the outer portion 30 and the hook 11 is arranged at one end of the inner portion 28. For example, the heat element 5 can be arranged at one end 4b of the connection plate and the hook 11 for receiving the part of the track is arranged at the opposite end of the connection plate. The connection plate is made of a thermally conducting material and the inner portion 28 has an upper surface adapted to be in thermal contact with the bottom section of the rail. In this example, the inner portion 28 extends between the stop element 26 and the end 4a of the connection plate, and the outer portion 30 extends between the stop element 26 and the end 4b of the connection plate.

FIG. 3 shows the heating device 1a connected to a railway track. The railway track comprises a rail 40 having a bottom section 42. The lower part of the rail is arranged between the stop element 26 and the hook 11 as shown in the figure. The first section 9 of the connection plate 3 is inserted under the bottom section 42 of the rail. The bottom section 42 is in physical contact with the upper surface 34 of the first section 9. A part of the bottom section of the rail is positioned in the space 12 between the first and second sections 9, 10. The securing member 7 is tightened so that the part of the bottom section positioned in the space 12 is clamped between the first section 9 and the tip 18 of the securing member. The second section 10 and the securing member 7 is disposed at one side of the rail, and the heat element 5 is disposed at the opposite side of the rail. Heat is transferred from the heat element 5 to the rail via the first section 9 of the connection plate.

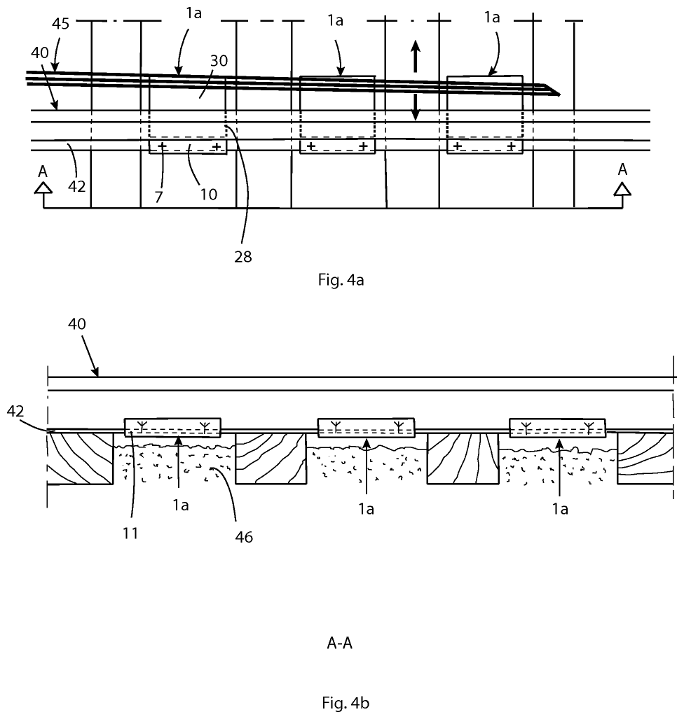

FIG. 4a shows a view from above of a part of a railway switch comprising a plurality of heating devices 1a arranged along the switch. FIG. 4b shows a cross-section A-A through the railway switch shown in FIG. 4a. The railway switch comprises two parallel rails 40, but only one of the rails 40 is shown in the figures. As seen from the figures, the lower part 42 of the rail is in physical contact with the inner portion 28 of the connection plate, and the outer portion 30 of the connection plate is protruding from the rail towards the center of the track. The switch has tongue 45 arranged movable between the rails of the switch. The connection plate is protruding from the rail 40 towards the tongue 45 of the switch. The connection plate is arranged between the rail 40 and the tongue 45 to allow snow and ice between the rail and the tongue to be melted. The system will slowly accumulate heat in the rail by means of transfer from the heat element through the connecting plate to the rail and then on moment's notice, when ice blocks are dropped from passing trains, return the accumulated energy from the rail to the connecting plate to clear the area between the rail and a tongue of the switch by melting off lodged ice.

A method for mounting the heating device comprises inserting the other end 4b of the connection plate 3 underneath the rail 40 from outside of the track, towards the center of the railroad so that the bottom section 42 of the rail is inserted in said space 12 through said opening 14, as shown in FIG. 4 a-b, and clamping the bottom section 42 of the rail between the securing member 7 and the first section 9 of the connection plate using the second section 10 as a restraint so that the lower part 42 of the rail is in physical contact with the inner portion 28 of the connection plate, and the outer portion 30 of the connection plate is protruding from the rail towards the center of the track to allow snow and ice between the rails to be melted, as shown in FIG. 3.

FIG. 5 shows a second example of a heating device 1b according to the invention. Like or corresponding parts in the figures are indicated with like numerals. The heating device 1b differs from the previously described heating device 1a in that the heat element 5 is positioned on the upper surface of the second section 9′ of the connection plate 3′. The connection plate 3′ has a different design. The second section 9′ of the connection plate 3′ is shorter, and the second end 4b of the connection plate is provided with an upwardly protruding part to hold the heat element 5 in place as well as working as a stop element for the rail

The present invention is not limited to the embodiments disclosed but may be varied and modified within the scope of the following claims. For example, the number of securing elements can be one, two, or more than two. The shape of the hook may also vary in dependence of the shape of the bottom section of the rail.

1. Heating device (1a; 1b) for melting snow and ice from a railway track, wherein the heating device comprises a connection plate (3, 3′), a heat element (5) attached to the connection plate, and at least one securing member (7) for securing the connection plate to the track, and the securing member (7) is configured to clamp a part of the track between the securing member (7) and the connection plate, characterized in that an outer portion (8) of the connection plate (3) is bent inwards so that a hook (11) is formed at an end (4a) of the connection plate for receiving a part of the track, and the hook is provided with at least one through hole (16) for receiving the at least one securing member.

2. The heating device according to claim 1, wherein the connection plate (3, 3′) is solid and made in one piece.

3. The heating device according to claim 1, wherein the connection plate (3, 3′) is made of a resilient material.

4. The heating device according to claim 1, wherein the connection plate (3, 3′) is made of high-tensile steel, high-tensile aluminum, or high-tensile aluminum alloys.

5. The heating device according to claim 1, wherein the heat element (5) is arranged on the outside of the connection plate (3, 3′).

6. The heating device according to claim 1, wherein the heat element (5) is attached to a bottom surface (22) or an upper surface (24) of the connection plate (3, 3′).

7. The heating device according to claim 1, wherein the connection plate (3, 3′) comprises a first section (9;9′) that defines a first plane, and the hook comprises a second section (10;10′) that defines a second plane.

8. The heating device according to claim 7, wherein the angle (a) between the first and second planes is less than 25°.

9. The heating device according to claim 7, wherein the thickness (t2) of the first section (9;9′) of the connection plate (3) is less than 30 mm, and preferably less than 25 mm.

10. The heating device according to claim 1, wherein the other end (4b) of the connection plate (3) has a thickness of less than 40 mm.

11. The heating device according to claim 1, wherein the heat element (5) is plate shaped and the thickness (t1) of the heat element is less than 30 mm.

12. Use of the heating device according to any of the claims 1-11 for heating a railway switch including a rail (40) and a tongue (45) arranged movable relative the rail, and the connection plate (3, 3′) is arranged so that it extends between the rail and the tongue of the switch to allow snow and ice between the rail and the tongue to be melted.
